(19) United States
(12) Patent Application Publication
(10) Pub. No.: US 2024/0059889 A1
(43) Pub. Date: Feb. 22, 2024

(54) RAPID-CURING RESIN COMPOSITION AND COMPOSITE MATERIAL CONTAINING THE SAME

(71) Applicant: Cytec Industries Inc., Princeton, NJ (US)

(72) Inventor: Carmelo Luca RESTUCCIA, Chester (GB)

(73) Assignee: Cytec Industries Inc., Princeton, NJ (US)

(21) Appl. No.: 18/258,178

(22) PCT Filed: Dec. 19, 2021
(86) PCT No.: PCT/US2021/064251

§ 371 Date: Jun. 16, 2023

Related U.S. Application Data
(60) Provisional application No. 63/127,650, filed on Dec. 18, 2020.

(51) Int. Cl. C08L 63/06; C08G 59/56; C08J 5/24

(52) U.S. Cl. CPC C08L 63/06; C08G 59/56; C08J 5/243; C08K 3/013

(57) ABSTRACT

A thermoset resin composition and composite materials containing reinforcement fibers impregnated with the thermoset resin composition. The thermoset resin composition contains: (a) a combination of multifunctional epoxy resins; (b) 4,4′-meth-ylenebis(2,6-xylidine) as a curative for the epoxy resins; and (c) a thermoplastic component, wherein the thermoset resin composition is void of any catalyst or accelerator that is reactive with the epoxy resins.

### DETAILED DESCRIPTION

Fiber-reinforced polymeric composite materials have been used for fabricating load-bearing structures. High-performance structures such as primary and secondary structures of aircrafts and automotive body parts may be fabricated by laying up multiple layers of thermosettable prepregs on a mold surface followed by consolidation and curing. Each thermosettable prepreg is composed of a layer of reinforcement fibers impregnated or embedded in a matrix resin, which includes thermoset resins such as epoxy resins. Epoxy resins are used because they are known for their thermal and chemical resistance.

The design of composite materials for use in aerospace structures typically takes into account the hot/wet performance of the cured material. Hot/wet performance refers the mechanical properties of the material when tested after prolonged exposure to relatively high temperatures and high humidity conditions. In the manufacturing of aircrafts, one must consider the extreme environmental factors such as high temperatures and high level of humidity since aircrafts can experience high temperatures for hours while the humidity levels are unknown. As such, composite materials for aerospace applications are usually evaluated for use in hot and wet conditions.

Regarding the prepregs, one property of the prepreg to be considered is its “out-life” or shelf-life, which refers to the length of time an uncured prepreg can be stored at room temperature (20° C.-25° C.) and can still retain sufficient tack and drape (or flexibility) to allow the manufacturing of composite parts of acceptable quality from such prepreg. The “tack” of an uncured prepreg is a measurement of the capability of an uncured prepreg to adhere to itself and to a mold surface, and is an important factor during laying up and molding operations, in which multiple plies of prepregs are laid up to form a laminate, which is subsequently cured to form the composite part.

Typically, the manufacture of cured composite structures from thermosettable prepregs is a relatively lengthy process. The curing of a prepreg layup is often the major contributor to the total time taken. The majority of prepregs that is used for manufacturing large aerospace structures is typically cured in an autoclave, which is a large pressurized oven. In such a scenario, it is normal for the cure cycle to begin with a temperature ramp from ambient temperature up to the desired cure temperature. The rate at which the temperature is ramped is typically 0.5° C./min to 2° C./min and the final cure temperature is often about 180° C. or higher. The dwell time (or hold time) at the final cure temperature is usually about 2 to 3 hours, which is then followed by a cooling step to cool the cured material down to room temperature at a rate of 2° C./min to 3° C./min. The total duration of the cure cycle is typically therefore in the range of 7 to 12 hours. The slow heating ramp to the final cure temperature and the long dwell time at high temperatures are required in order to achieve high degree of cure and desirable thermo-mechanical properties.

Higher ramp rates are not necessarily achievable or desirable when large tools are required or when thick composite structures are cured due to the possible occurrence of uncontrolled exothermicity or non-uniformity in the degree of cure through the thickness of a composite part. Various attempts were made to formulate epoxy-based prepregs, which could be cured in an autoclave at temperatures below 180° C. and with dwell times of less than 2 hours.

In order to reduce the cure temperature or the duration of the curing cycle, a pre-reacted epoxy resin, catalysts, co-curing agents or a combination thereof are normally combined with the main amine curing agent. The presence of a pre-reacted epoxy or a catalyst or a co-curing agent could result in undesirable effects on the handling and processing capabilities of the prepreg at ambient conditions, such as tack, drape, storage time, and out-life. Alternatively, very reactive aromatic curing agents, such as 4,4′-methylenedianiline, have been used in the past but they are now classified by some government authorities as carcinogens and/or mutagens and therefore not desirable for future applications. Catalyzed epoxy resin compositions which can be cured at temperatures below 180° C. for less than 2 hours have been found to result in cured materials that are normally characterized by hot/wet T_{g} below 150° C. and to have a propensity to absorb more moisture than cured epoxy-based materials that are cured via a standard 180° C./2 hr cure cycle, resulting in a substantial reduction in hot/wet mechanical performance. Hot/wet T_{g} refers to the glass transition temperature of a cured composite which has previously been subjected to a prolonged conditioning at high relative humidity (e.g., 85%-95%) and at elevated temperatures (e.g., 70° C.-90° C.) until the samples have reached saturation. Such hot/wet T_{g} can be determined by EN6032. The highly reactive catalyzed epoxy resin compositions also have the propensity to produce local uncontrolled exothermicity when they are used to manufacture thick composite structures. Uncontrolled exothermicity makes the manufacturing process unsafe or results in composite structures with a non-uniform degree of cure from the top to the center portion of the cured part. Intermediate dwells of variable duration, e.g., 0.5 to 2 hours, at a temperature of 100° C.-140° C. can be used to mitigate such issues but this would further prolong the duration of the curing cycle and defeat the purpose of adding a catalyst to the resin composition.

A solution to address the above mentioned issues relating to curing cycle for processing thermoset prepregs and hot/wet performance of the cured composite parts produced from such prepregs is disclosed herein. Such solution includes providing a thermoset resin composition for producing a composite material, particularly, a fiber-reinforced prepreg, containing a combination of different epoxy resins, an ortho methyl substituted aromatic diamine as the main amine curing agent, one or more thermoplastic components, and, optionally, some fillers. The “main” amine curing agent means that such amine constitutes an amine molar content of 50% of the total molar amount of all amine curing agents in the thermoset resin composition. In some embodiments, the ortho methyl substituted aromatic diamine is the only amine curing agent in the composition.

The epoxy resins in the thermoset resin composition are preferably multifunctional epoxy resins having two or more epoxide groups per molecule.

The thermoplastic component of the thermoset resin composition includes one or more toughening agents selected from thermoplastic polymers and thermoplastic particles. In some embodiments, a combination of a thermoplastic polymer and thermoplastic particles are present in the resin composition.

The ortho methyl substituted aromatic diamine (the main amine) contains two primary amino groups per molecule and two methyl group substituents at a position ortho to each amino group. The preferred aromatic diamine is 4,4′-methylenebis(2,6-xylidine), synonym of 4,4′-methylenebis (2,6-dimethylaniline), represented by the following chemical structure:

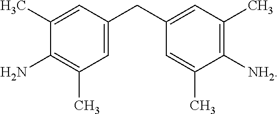 [SMILES: Cc1cc(Cc2cc(C)c(N)c(C)c2)cc(C)c1N]

The preferred aromatic diamine is a crystalline solid with a melting point of 116° C., is stable at ambient temperature and humidity and does not cause any pronounced advancement of the thermoset resins, particularly, epoxy resins, during the prepreg manufacturing process, which is typically carried out at temperatures in the range of 80° C. to 130° C. Therefore, the presence of such aromatic diamine does not affect the tack, handling capability, shelf life and formability of the uncured prepreg. The term “formability” in this context refers to the ability of the material to conform or drape onto a three-dimensional tool surface.

4,4′-methylenebis(2,6-dimethylaniline) is distinguishable from 4,4′-methylenebis(2,6-diethylaniline) or 4,4′-methylenebis(2,6-diisopropylaniline) in that the methyl groups in the position ortho to the primary amine are stronger electron-donating and less steric hindering moieties as compared to the ethyl or isopropyl groups due to the steric, inductive and hyperconjugation effects. Although alkyl groups can all be considered as weak electron activating groups, when they are in position ortho to the amine group, they do not greatly contribute to the basicity of the aromatic diamine due to the steric hindrance of the aliphatic groups which are in close proximity to the primary amine. Such effect is more pronounced in the case of bulky ethyl or 2-isopropyl groups (such as in the case of Lonzacure® M-DEA, M-MIPA and M-DIPA aromatic amines).

In addition, as the ethyl and isopropyl groups have, respectively, only two or one hydrogen atoms attached to the α-carbon atom directly linked to the aromatic ring, conversely to the methyl group which has three, the hyperconjugation effect in ethyl or isopropyl groups will be lesser than in the case of the methyl group, resulting in more electron donating power of methyl group over ethyl or isopropyl group. The described effects determine a higher reactivity of the primary aromatic amine comprising methyl groups in ortho position toward epoxy resins, and therefore, a higher kinetic of reaction at composite level can be achieved.

Lastly, the presence of 2,6 ortho substituting groups in the methylene dianiline molecule greatly reduces the safety and occupational health risks connected to the volatility of the molecule and its potential inhalation by operators. Thus, the propensity of the methylene dianiline molecule to act as a human hepatotoxin and an animal carcinogen is substantially reduced, thereby, making this curing agent a more suitable compound to use in resin formulations and composite materials for aerospace applications.

In some embodiments, 4,4′-methylenebis(2,6-xylidine) is used in combination with another aromatic amine or a plurality of other aromatic amines, provided that the molar content of 4,4′-methylenebis(2,6-xylidine) is ≥50% of the total molar amount of all aromatic amines. Other aromatic amine(s) that may be used in combination include: 3,3′-diaminodiphenylsulfone (3,3′-DDS); 4,4′-diaminodiphenylsulfone (4,4′-DDS); 1,4-bis(4-aminophenoxy)-2-phenylbenzene; 1,3-Bis(3-aminophenoxy)benzene; 4,4′-(m-phenylenediisopropylidene)dianiline; 4,4′-(p-phenylenediisopropylidene)dianiline; 2,2′-bis(4-(4-aminophenoxy)phenylpropane; 4,4′-bis(3-aminophenoxy)diphenylsulfone; 1,3-bis(3-aminophenoxy)benzene; and 4,4′-1,4-phenylenebis(1-methylethylindene)bisaniline.

The addition of relatively small quantities of other aromatic amines, particularly, aromatic diamines, could affect the solubility and compatibility of certain toughening agents in/with the epoxy-amine resin matrix in the uncured and cured state. For example, if a thermoplastic polymer (e.g., polyethersulfone) is used to improve the toughness of an epoxy resin matrix containing 4,4′-methylenebis(2,6-xylidine), a relatively small addition of a more compatible aromatic amine such as 4,4′ or 3,3′-diaminodiphenylsulfone could contribute to the formation of a more homogeneous and less phase separated blend upon curing. In such a scenario, the size of the separated thermoplastic domains dispersed into the epoxy resin could be reduced, and possibly, a more desirable morphology could be achieved (e.g., particulated morphology with thermoplastic domains smaller than 5 microns). Upon curing, the cured polymer matrix or the composite part containing reinforcement fibers embedded in such cured polymer matrix in general could be characterized as having a good balance in toughness/impact properties, hot-wet performance and resistance to aggressive solvents.

In some embodiments, the thermoset resin composition of the present disclosure includes the following components:
(A) a combination of (i) a difunctional polyepoxide and (ii) a tri-functional polyepoxide and/or tetra-functional polyepoxide;
(B) a curative component comprising 4,4′-methylenebis(2,6-xylidine) as the main amine curative for the polyepoxide(s); and
(C) a toughening component, preferably, comprising a combination of a thermoplastic polymer and thermoplastic particles,
wherein the relative amounts, in weight percentages (wt %), of the components are: 30-75 wt % A, 20-30 wt % B, and 5-40 wt % C, based on the total weight of the resin composition. For component B, 4,4′-methylenebis(2,6-xylidine) may be the only amine curative or used in combination with one or more other aromatic amines, preferably, aromatic diamines. When a combination of amine curatives are used for component B, the molar content of 4,4′-methylenebis(2,6-xylidine) is ≥50% of the total molar amount of all amines in the thermoset resin composition.

The relative amounts of components A and B are such that the mole ratio of epoxy to amine is between 0.9 and 1.1. This thermoset resin composition is void of any catalyst or accelerator that is reactive with the multifunctional polyepoxide(s). Optionally, this resin composition may further include inorganic fillers, such as conductive fillers, in an amount of 0.1-10 wt % based on the total weight of the resin composition.

In a preferred embodiment, the thermoset resin composition is free of any catalyst or accelerator that is reactive with the epoxy resins. Such catalyst or accelerator includes bisurea, a metal complex with carbon/late ligands, boron trifluoride or complex thereof, or any co-curing agent such as tertiary amines, imidazoles, phosphonium halides, and adducts with polyepoxides. Such tertiary amines include tris (dimethyl amino-methyl) phenol and benzyldimethylamine. The epoxy-based resin compositions containing such tertiary amines lack storage stability, and in most cases, must be used within 24 hours after the addition of these co-curing agents (as accelerators) or else the mixture begins to cure under normal storage conditions. The phosphonium halides include ethyl triphenyl phosphonium iodide. The adducts with polyepoxies include: (i) N-methyl-, N-(2-hydroxyethyl)-, N-octyl-, N-phenyl- and N-benzyl piperazine and N-methyl homopiperazine adduct with a polyglycidyl ethers of 4,4′-isopropylidenediphenol (bisphenol A); and (ii) imidazole adduct with monoepoxides, polyepoxides or phenolic/novolac resins, e.g., 2-ethyl-4-methyl imidazole adduct with the glycidyl polyether of 2,2-bis-(4-hydroxyphenyl) propane. The presence of such catalyst/accelerator and co-curing agents could result in undesirable effects on the properties, such as tack, drape, storage time, and shelf life, of the uncured prepreg at ambient conditions.

For the purpose of fabricating prepregs, the viscosity of the uncured thermoset resin composition may be in the range of 50-1500 Poise at 80° C. or 1-500 Poise at a temperature in the 120° C.-170° C. range.

A thermosettable prepreg may be fabricated by impregnating a layer of reinforcement fibers with the thermoset resin composition disclosed herein, wherein the resin composition constitutes 30% to 80%, or 30% to 65%, preferably, 40% to 50%, in volume fraction (%) based on the total volume of the prepreg.

The prepreg manufactured using the thermoset resin composition of the present disclosure can be cured at 160° C.-180° C. for 15-120 min to produce a cured composite material with a degree of cure of greater than 85% and a glass transition temperature (T_{g}) equal to or higher than 180° C. (more specifically, 180° C.-200° C.) in dry conditions and equal to or higher than 150° C. (more specifically, 150° C.-160° C.), in hot/wet conditions (after a 2 weeks conditioning at 70° C./85% humidity) as determined by EN6032. In some embodiments, curing is carried out at 160° C.-170° C. for 15-60 min.

The degree of cure of a thermoset resin composition or prepreg can be determined by Differential Scanning calorimetry (DSC). A thermoset resin composition undergoes an irreversible chemical reaction during curing. As the components in the resin system cure, heat is evolved by the resin, which is monitored by the DSC instrument. The heat of cure may be used to determine the percent cure of the resin material. As an example, the following simple calculation can provide the percent cure information:

% Cure=[ΔH_{uncured}−ΔH_{cured}]/[ΔH_{uncured}]×100%

where ΔH is the enthalpy generated by the uncured or cured sample.

A suitable curing cycle for a prepreg or prepreg layup containing reinforcement fibers impregnated with the thermoset resin composition of the present disclosure is as follows: ramp from room temperature (20° C.-25° C.) to 160° C. at 1° C./min, dwell at 160° C. for 60 min and ramp down to 60° C. at 3° C./min. The stability of the resin composition could allow a further reduction in the curing cycle duration by preheating the mould supporting the prepreg/prepreg layup to temperatures up to 80° C.-90° C. prior to ramping the temperature to 160-170° C. at ramp rates in the 0.5° C./min to 2° C./min range.

The total duration of the curing cycle can be therefore reduced to 3-5 hours from the industry standard of 7 to 12 hours while achieving equivalent thermo-mechanical performance.

The thermoset resin composition of the present disclosure is characterized by a controlled reactivity and does not require an intermediate temperature dwell step (holding at a temperature in the range of 100° C. to 140° C. for 30 to 60 minutes) when thick composite parts (having up to 56 mm in thickness) are cured using industry standard temperature ramp rates of 0.5° C./min to 2° C./min.

The cured composite material derived from using the thermoset resin composition of the present disclosure is characterized by low water uptake, e.g. <1.5% as determined by EN2378, and excellent thermo-mechanical properties in hot/wet conditions. Such thermo-mechanical properties refer to filled hole tensile strength as measured by EN6035, Bolt Bearing Strength as measured by EN6037, and Compression Strength After Impact (CAI) as measured by EN6038.

The terms “cure” and “curing” as used herein encompass polymerizing and/or cross-linking of a polymeric material brought about by mixing of based components, heating at elevated temperatures, or exposure to ultraviolet light and radiation.

### Thermoset Resins

The thermoset resin composition of the present disclosure is a hardenable or thermosettable resin composition. In preferred embodiments, the curable thermoset resin composition contains a combination of multifunctional epoxy resins or polyepoxides. As used herein, the term “multifunctional” epoxy resin or polyepoxide is a resin which has a functionality of two or higher. The term “polyepoxide” is used interchangeably with “epoxy resin” in the present disclosure. Preferred multifunctional resins are difunctional, trifunctional and tetrafunctional epoxy resins, although epoxy resins having greater functionality may also be used, for instance those having 5 or 6 epoxy groups. The term “multi-functional” encompasses resins that have non-integer functionality, for instance, epoxy phenol novolac (EPN) resins.

Suitable epoxy resins include polyglycidyl derivatives of aromatic diamine, aromatic mono primary amines, aminophenols, polyhydric phenols, polyhydric alcohols, polycarboxylic acids. Examples of suitable epoxy resins include polyglycidyl ethers of the bisphenols such as bisphenol A, bisphenol F, bisphenol C, bisphenol S and bisphenol K; and polyglycidyl ethers of cresol and phenol based novolacs.

Suitable difunctional epoxy resins include those based on: diglycidyl ether of Bisphenol F, Bisphenol A (optionally brominated), glycidyl ethers of phenol and cresol epoxy novolacs, glycidyl ethers of phenol-aldehyde adducts, glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, or any combination thereof. Difunctional epoxy resins are preferably selected from diglycidyl ether of Bisphenol F (DGEBF), diglycidyl ether of Bisphenol A (DGEBA), diglycidyl ether of dihydroxy naphthalene, or any combination thereof.

Suitable tri-functional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl ethers, epoxidised olefins, brominated resins, triglycidyl aminophenols (including triglycidyl p-aminophenol (TGPAM) and triglycidyl m-aminophenol), aromatic glycidyl amines, heterocyclic glycidyl imidines and amides, glycidyl ethers, fluorinated epoxy resins, triglycidyl derivatives of hydroxyl phenyl methane or any combination thereof.

Suitable tetra-functional epoxy resins include: tetraglycidyl diamino diphenylmethane (TGDDM); tetraglycidyl-bis(4-aminophenyl)-1,4-diiso-propylbenzene; tetraclycidyl-bis(4-amino-3,5-dimethylphenyl)-1,4-diisopropylbenzene, tetra glycidyl derivatives of hydroxyphenyl ethane and tetraglycidyl-m-xylenediamine.

In preferred embodiments, a difunctional epoxy resin is used in combination with a tri-functional epoxy resin and/or a tetra-functional epoxy resin.

### Toughening Agents

Suitable toughening agents (or tougheners) for use in the thermoset resin composition include thermoplastic polymers, which may be present in the form of particles. The term “particles” as used herein encompass particulate materials of various shapes including, but are not limited to, spherical and non-spherical particles. In some embodiments, the thermoplastic toughening particles include particles that are substantially insoluble in the thermoset resin composition during curing thereof, and remain as discreet particles in the cured material after curing. The insoluble thermoplastic particles that are suitable for the purposes herein include particles of aliphatic polyamides (PA), cycloaliphatic polyamides, aromatic polyamides, polyphthalamide (PPA), polyaryletherketones (PAEK), such as polyetheretherketone (PEEK) and polyetherketoneketone (PEKK), polyphenylene sulfide (PPS), polyamideimide, liquid crystal polymers (LCPs), polyimides, copolymers thereof, and derivatives thereof. These toughening particles do not have a conductive coating such as metal.

Insoluble thermoplastic particles have been found to be effective as interlaminar tougheners for avoiding the loss of hot/wet performance. Because these thermoplastic particles remain insoluble in the polymer matrix after curing, they impart improved toughness, damage tolerance, hot/wet performance, processing, micro-cracking resistance, and reduced solvent sensitivity to the cured polymer matrix.

The insoluble thermoplastic particles may be used in combination with a soluble thermoplastic polymer as an additional toughening agent. Such soluble thermoplastic polymer may be selected from: polyarylsulfones (e.g. polyethersulfone (PES), polyetherethersulfone (PEES), PES-PEES copolymer), polyphenyleneoxides (PPO), thermoplastic phenoxy resins, polysulfones, polyetherimide (PEI) and polyimides (PI). These soluble thermoplastic polymers may be added to the resin composition as solids (e.g., powder), which dissolve into the resin composition when the composition is heated during the preparation of the composition or during the impregnation of the reinforcement fibers to form the prepreg. As used herein, “dissolves” into the resin means forming a homogeneous or continuous phase with the resin.

Tougheners may also be selected from elastomeric polymers with functional groups capable of reacting with the multifunctional epoxy resins during curing. Suitable functional groups include, but are not limited to, —COOH, —NH, —NH2, OH, —SH, —CONH2—, —CONH—, —NHCONH—, —NCO, —NCS, and oxirane or glycidyl group. Exemplary elastomers include, without limitation, natural rubber, styene-butadiene rubber, polyisoprene, polyisobutylene, polybutadiene, isoprenebutadiene copolymer, neoprene, nitrile rubber, butadiene-acrylonitrile copolymer, butyl rubber, butyl nitrile rubber, polysulfide elastomer, acrylic elastomer, acrylonitrile elastomers, silicone rubber, polysiloxanes, polyester rubber, disocyanatelinked condensation elastomer, EPDM (ethylene-propylene diene rubbers), chlorosulfonated poly ethylene, fluorinated hydrocarbons, polybutyl acrylate-methyl methacrylate (MAM) copolymers, thermoplastic elastomers such as (AB) and (ABA) type of block copolymers of styrene and butadiene or isoprene, and (AB)n type of multi-segment block copolymers of polyurethane or polyester, and the like.

In a preferred embodiment, a polyarylsulfone, e.g., polyethersulfone (PES), is used as the toughening agent. In another preferred embodiment, a combination of insoluble polyamide particles and a soluble polyarylsulfone, e.g. PES, are used as toughening agents in the thermoset resin composition.

The toughening component may be present in an amount in the range of 5-40 wt %, including 5-23 wt %, based on the total weight of the thermoset resin composition.

### Other Additives

Optionally, the thermoset resin composition of the present disclosure also contains one or more additives selected from rheology control agents, tackifiers, inorganic or organic fillers, stabilizers, inhibitors, pigments, dyes, flame retardants, reactive diluents, conductive fillers and other additives well known to those skilled in the art for modifying the properties of the resin before or after curing.

When present, inorganic or organic fillers constitute about 0.1-10 wt % based on the total weight of the resin composition. In some embodiments, conductive fillers are added to the thermoset resin composition. Generally, the conductive fillers may have any suitable three-dimensional shapes including, for example, spherical, ellipsoidal, spheroidal, discoidal, dendritic, rods, discs, cuboid or polyhedral.

Suitable conductive fillers for the thermoset resin composition include, but are not limited to, carbon nano-materials such as carbon nano-tubes (CNTs), carbon nano-fibres, carbon nano-needles, carbon nano-sheets, carbon nano-rods, carbon black, graphite nano-platelets or nano-dots, graphenes, graphites or a combination thereof with or without a partial or total metallic coating or other fullerene materials and combinations thereof. The term “carbon nanomaterials”, as used herein, refers to materials having at least one dimension smaller than about 0.1 micrometer (<100 nanometers) and composed entirely or mostly of carbon atoms arranged, at the molecular scale, in pentagons or hexagons, or both.

### Reinforcement Fibers

For fabricating high-performance composite materials and prepregs, suitable reinforcement fibers have a high tensile strength, preferably greater than 500 ksi (or 3447 MPa) as measured according to ASTM C1557-14. Fibers that are useful for this purpose include carbon or graphite fibers, glass fibers and fibers formed of silicon carbide, alumina, boron, quartz, and the like, as well as fibers formed from organic polymers such as for example polyolefins, poly(benzothiazole), poly(benzimidazole), polyarylates, poly(benzoxazole), aromatic polyamides, polyaryl ethers and the like, and may include mixtures having two or more such fibres. Preferably, the fibers are selected from glass fibers, carbon fibers and aromatic polyamide fibers, such as the fibers sold by the DuPont Company under the trade name KEVLAR. The reinforcement fibers may be used in the form of discontinuous fibers, as continuous unidirectional or multi-directional fibers, or as woven, non-crimped, or nonwoven fabrics. The woven form may be selected from plain, satin, or twill weave style. The non-crimped fabric may have a number of plies and fiber orientations.

The reinforcement fibers may be in the form of continuous tows, each tow made up of multiple filaments, unidirectional or multidirectional fibers, tapes of unidirectional fibers, or nonwoven or woven fabrics. In preferred embodiments, the reinforcement fibers for the prepreg are unidirectional carbon fibers. The term “unidirectional” refers to the unidirectional position of parallel, spaced apart fibers, i.e., orientation in the same direction.

### Manufacturing of Prepregs and Composite Structures

The term “prepreg” as used herein refers to a sheet or layer of reinforcement fibers that has been impregnated with a curable resin composition. The prepregs may be fully impregnated prepregs or partially impregnated prepregs. The term “impregnated” as used in herein refers to fibers that have been subjected to an impregnation process whereby the fibers are partly surrounded by a resin or fully embedded in a bulk of resin, also referred to as “matrix resin”.

In general terms, a layer of dry fibers can be impregnated with the curable resin by heating the curable resin to its molten state and introducing said molten curable resin on and into the layer of dry fibers. Typical impregnating methods include:
(1) Continuously moving the reinforcing fibers through a bath of solvated resin composition to fully or substantially wet out the fibers; followed by the application of heat to evaporate the solvent; or
(2) Pressing a top resin film and/or a bottom resin film against a layer of reinforcing fibers under elevated temperature (hot-melt technique).

To make a prepreg ply, a resin film is manufactured first by coating the thermoset resin composition of the present disclosure onto a release paper. Next, one or two of such resin film is/are laminated onto one or both sides of a layer of reinforcement fibers under the aid of heat and pressure to impregnate the fibers, thereby forming a fibre-reinforced resin layer (or prepreg ply) with specific fiber areal weight (FAW) and resin content. If toughening particles having particle sizes larger than the spacings between the fiber filaments are present, they are filtered out during the laminating process, and remain external to the fiber layer.

To form a composite structure, a plurality of prepreg plies may be laid up on a tool in a stacking sequence to form a “prepreg layup.” The prepreg plies within the layup may be positioned in a selected orientation with respect to one another, e.g. 0°, ±45°, 90°, etc. The prepreg layup may be manufactured by techniques that may include, but are not limited to, hand lay-up, automated tape layup (ATL), advanced fiber placement (AFP), and filament winding. The prepreg layup is then cured according to the curing cycle disclosed herein.

### EXAMPLES

### Example 1

The epoxy resin formulations (1a-1i) according to Table 1 below were prepared by pre-blending the epoxy components at 70° C., polyethersulfone (PES) was then added to form a mixture which was then heated at 115° C. until full dissolution of PES was achieved. The mixture was then cooled down to 80° C., the polyamide particles and then the amine curing agent were added and mixed until a homogeneous composition was obtained.

TABLE 1

| | Resin code | | | | | | | | |
|---|---|---|---|---|---|---|---|---|---|
| | 1a | 1b | 1c | 1d | 1e | 1f | 1g | 1h | 1i |
| Component | w/w % | | | | | | | | |
| DGEBPF | 25.6 | 25.8 | 12.4 | 12.6 | — | — | — | — | |
| TGDDM | 14.0 | 12.9 | 12.4 | 25.1 | 13.0 | 12.5 | 25.4 | 29.1 | 29.1 |
| DGEBPA | — | — | — | — | 26.0 | 12.5 | 12.6 | — | |
| TGPAP | 11.9 | 12.9 | 24.8 | 12.6 | 13.0 | 24.9 | 12.6 | 25.6 | 25.6 |
| Polyethersulfone | 18.0 | 18.0 | 18.0 | 18.0 | 18.0 | 18.0 | 18.0 | 19.0 | 19.0 |
| Polyamide | 5.0 | 5.0 | 5.0 | 5.0 | 5.0 | 5.0 | 5.0 | — | — |
| particles | | | | | | | | | |
| 4,4′-DDS | — | — | — | — | — | — | — | — | 29.1 |
| 4,4′-methylenebis | 25.5 | 25.5 | 27.4 | 26.8 | 24.9 | 27.1 | 26.5 | 26.9 | — |
| (2,6-xylidine) | | | | | | | | | |

DGEBPF is a bisphenol F based epoxy. TGDDM is a tetraglycidyl diamino-diphenylmethane epoxy resin. TGPAP is triglycidyl para-aminophenol epoxy resin. DGEBPA is a bisphenol A based epoxy resin. 4,4′-DDS is 4,4′-diaminodiphenylsulfone. The polyamide particles had a melting point of about 250° C. (as determined by DSC).

Each of the resulting formulations was then casted in a steel mould and cured in an oven according to one of the cure cycles described in Table 2 to form resin plagues.

TABLE 2

| Cure cycle | 1 | 2 | 3 |
|---|---|---|---|
| Ramp rate [° C./min] from 25° C. | 1 | 1 | 2 |
| to dwell temperature | | | |
| Dwell Temperature [° C.] | 160 | 170 | 180 |
| Dwell time [min] | 60 | 30 | 120 |
| Ramp rate [° C./min] from dwell | 3 | 3 | 3 |
| temperature to 25° C. | | | |

Approximately 2 mm thick test coupons were then extracted from each of the cured resin plaques and the onset T_{g} of the cured resin plaques was measured at the intersection of the extrapolated tangents drawn from points on the storage modulus curve before and after the onset of the glass transition event according to EN6032 at 1 Hz of frequency. Wet coupons were pre-conditioned in a climatostatic chamber at 70° C. and 85% humidity up to saturation according to EN2823 and then tested by Dynamic Mechanical Analysis (DMA). The extent of cure (EoC) of the cured resin was measured by Differential Scanning calorimetry (DSC) and calculated as the ratio between the heat of reaction in J/g of, respectively, the cured and uncured resin and expressed as a percentage. DSC was run at 10° C./min in the −50° C. to 350° C. temperature range. The T_{g} and EoC data of the cured resins are reported in Table 3.

TABLE 3

| | Tg | Tg | | Tg | Tg | | Tg | Tg | |
|---|---|---|---|---|---|---|---|---|---|
| | Dry | Wet | EoC | Dry | Wet | EoC | Dry | Wet | EoC |
| | (° C.) | (° C.) | % | (° C.) | (° C.) | % | (° C.) | (° C.) | % |
| Resin | Cure cycle | | | | | | | | |
| code | 1 | | | 2 | | | 3 | | |
| 1a | 189 | 157 | 88 | 188 | 156 | 91 | — | | |
| 1b | 182 | 153 | 87 | 195 | 156 | 89 | — | | |
| 1c | 189 | 158 | 87 | 195 | 159 | 91 | — | | |
| 1d | 188 | 155 | 85 | 194 | 159 | 87 | — | | |
| 1e | 192 | 156 | 87 | 195 | 155 | 89 | — | | |
| 1f | 191 | 156 | 85 | 195 | 159 | 89 | — | | |
| 1g | 188 | 155 | 85 | 194 | 159 | 87 | — | | |
| 1h | 191 | 150 | 86 | 195 | 157 | 86 | — | | |
| 1i | 150 | 126 | 71 | 163 | 132 | 76 | 185 | 150 | 89 |

As shown in Tables 2 and 3, the use of 4,4′-methylenebis(2,6-xylidine) as a single component curing agent in the resins 1a to 1h, which were cured for 30-60 minutes at 160° C.-170° C., resulted in T_{g} numbers, in both dry or H/W conditions, which are equal or better than the T_{g} of the resin 1i, which contains a more conventional 4,4′-DDS and was cured at 180° C. (a higher temperature) for 2 hours (a longer dwell time).

When resin 1i was cured at 160° C.-170° C. for 30-60 minutes, the measured T_{g} were approximately 25° C.-35° C. lower than for the resins 1a to 1h, which were cured with 4,4′-methylenebis(2,6-xylidine). In addition, a degree of cure in the 71%-76% range could only be achieved using 4,4′-DDS while all of the evaluated cured resins derived from compositions containing 4,4′-methylenebis(2,6-xylidine) as a curing agent achieved a degree of conversion in the 85%-91% range.

### Example 2

The resin formulation 1a of Table 1 was cast onto a release paper to form a resin film. Two of such resin films were used to impregnate a layer of unidirectional carbon fibers (IMS65E23-24K-830tex from Teijin) to produce a unidirectional (UD) prepreg with a fiber areal weight (FAW) of 268 gsm and 34% resin content.

The UD prepreg was used to make test panels. Each test panel was a laminate of prepreg plies. The test panels were manufactured in accordance to EN2565 and cured in an autoclave according to the cure cycle 1 described in Table 2 of Example 1. The thermo-mechanical tests were carried out on the cured panels and the results are reported in Table 4.

TABLE 4

| | | Test | | | |
|---|---|---|---|---|---|
| | | Temperature | | | |
| Test | Method | [° C.] | Conditioning | Average | Unit |
| CSAI | EN6038 | RT | AR | 215 | MPa |
| CSAI | EN6038 | 70° C. | 70° C./WET | 213 | MPa |
| G_{ic} | EN6033 | RT | RT/DRY | 546 | J/m2 |
| ILSS | EN2563 | RT | AR | 89 | MPa |
| ILSS | EN2563 | 70° C. | 70° C./WET | 62 | MPa |
| FHT | EN6035 | RT | RT/DRY | 689 | MPa |
| FHT | EN6035 | 70° C. | 70° C./WET | 740 | MPa |
| BBS | EN6037 | RT | AR | 887 | MPa |
| BBS | EN6037 | 70° C. | 70° C./WET | 785 | MPa |
| Tg | EN6032 | RT | AR | 180 | ° C. |
| Tg | EN6032 | 70° C. | 70° C./WET | 155 | ° C. |
| EoC | Internal | — | AR | 92 | % |

In Table 4, AR stands for “as received” while RT stands for room temperature (about) 25C°. 70° C./WET stands for a conditioning process at relatively high temperature (70° C.) and high humidity levels (85%) to achieve the saturation of the test coupons.

G_{ic} is the measurement of inter-laminar fracture toughness in mode I, which was determined according to EN6033. ILSS is the apparent interlaminar shear strength which was measured according to EN2563. CSAI is the Compression Strength After Impact which was measured after a 30 Joule impact and in accordance to EN6038. FHT is the notched tensile strength as measured by EN6035. BBS is the bolt bearing strength which was measured by EN6037. T_{g} is the glass transition temperature of the cured test panels and was determined by DMA and according to EN6032. The extent of cure (EoC) of the test panel was measured by DSC and calculated as the ratio between the heat of reaction in J/g of, respectively, the cured test panel and the uncured prepreg, and expressed as a percentage. A temperature ramp experiment with a temperature rate of 10° C./min from −50° C. to 350° C. was used to measure the heat of reaction.

As shown in Table 4, the cured panel reached a degree of cure of greater than 90% and hot/wet (H/W) T_{g} of 155° C. when cured at 160° C. for 1 hour. The cured panel also exhibited high delamination resistance of 546 J/m 2 and damage tolerance of 215 MPa. Moreover, no reduction in CSAI or FHT were observed after being exposed to a conditioning at 70° C. and 85% humidity for two weeks. Relatively low reductions in BBS and ILSS were also observed after exposure to such H/W conditions.

### Example 3

The resin formulation 1h of Table 1 was deposited onto a silicone release paper to form a film. The resulting resin film was used to impregnate a layer of unidirectional carbon fibres (SGL Sigrafil® C T50 4.4/255 E100) on a prepreg manufacturing line, which produced a prepreg with a nominal fiber areal weight of 190 g/m² at 35% of resin content.

The prepreg was used to make test panels. Each test panel was a laminate of prepreg plies. Test panels were manufactured in accordance to EN2565 and cured in an autoclave according to the cure cycle 1 described in Table 2 of Example 1. The thermo-mechanical tests were carried out on the cured panels and the results are reported in Table 4.

TABLE 4

| | | Test Temp. | | | |
|---|---|---|---|---|---|
| Test | Method | [° C.] | Conditioning | Unit | Average |
| 0 Tensile strength (0TS) | ASTM | RT | RT/Dry | MPa | 2209.9 |
| 0 Tensile modulus (0TM) | D3039 | | | GPa | 130.5 |
| 0 Tensile strength (0TS) | | 120 | 70° C./WET | MPa | 1599.8 |
| 0 Tensile modulus (0TM) | | | | GPa | 141.3 |
| 0 Compressive strength | ASTM | RT | RT/Dry | MPa | 1375.7 |
| (0CS) | D6641 | | | | |
| 0 Compressive modulus | | | | GPa | 124.1 |
| (0CM) | | | | | |
| 0 Compressive strength | | 120 | 70° C./WET | MPa | 1279.9 |
| (0CS) | | | | | |
| 0 Compressive modulus | | | | GPa | 121.8 |
| (0CM) | | | | | |
| 90 Compressive strength | | RT | RT/Dry | MPa | 199.7 |
| (90CS) | | | | | |
| 90 Compressive | | | | GPa | 8.7 |
| modulus (90CM) | | | | | |
| 90 Compressive strength | | 120 | 70° C./WET | MPa | 118.7 |
| (90CS) | | | | | |
| 90 Compressive | | | | GPa | 7.3 |
| modulus (90CM) | | | | | |
| 90 Tensile strength | ASTM | RT | RT/Dry | MPa | 63.9 |
| (90TS) | D3039 | | | | |
| 90 Tensile modulus | | | | GPa | 7.9 |
| (90TM) | | | | | |
| 90 Tensile strength | | 120 | 70° C./WET | MPa | 24.4 |
| (90TS) | | | | | |
| 90 Tensile modulus | | | | GPa | 6.4 |
| (90TM) | | | | | |
| Interlaminar shear | ASTM | RT | RT/Dry | MPa | 91.6 |
| strength (ILSS) | D2344 | | | | |
| Interlaminar shear | ASTM | 120 | 70° C./WET | MPa | 62.6 |
| strength (ILSS) | D2344 | | | | |
| In-plane shear strength | ASTM | RT | RT/Dry | MPa | 126.1 |
| (IPSS) | D3518 | | | | |
| In-plane shear modulus | | | | GPa | 4.1 |
| (IPSM) | | | | | |
| In-plane shear strength | | 120 | 70° C./WET | MPa | 75.5 |
| (IPSS) | | | | | |
| In-plane shear modulus | | | | GPa | 2.6 |
| (IPSM) | | | | | |
| Open hole compression | ASTM | RT | RT/Dry | MPa | n/a |
| (OHC) | D6464 | | | | |
| Open hole compression | ASTM | 120 | 70° C./WET | MPa | 277.8 |
| (OHC) | D6464 | | | | |
| Compressive strength | ASTM | RT | RT/Dry | MPa | 177.6 |
| after impact (CSAI) | D7137 | | | | |
| Compressive strength | | 120 | 70° C./WET | MPa | 144.4 |
| after impact (CSAI) | | | | | |
| Un-notched | ASTM | RT | RT/Dry | MPa | 710.9 |
| Compressive strength | D6641 | | | | |
| (UNC) | | | | | |
| Un-notched | | 120 | 70° C./WET | MPa | 547.8 |
| Compressive strength | | | | | |
| (UNC) | | | | | |

### Example 4—Exothermicity

The exothermicity of the prepreg described in Example 3 was evaluated by making two laminates with a nominal thickness of, respectively, 30 mm (Panel 4.1) and 56 mm (Panel 4.2) from the prepreg and curing them in an autoclave. A thermocouple was placed at the center of each laminate (TC2) while a second one in the same position but between the two top layers (TC1). Each prepreg laminate was cured according to cure cycle 1 disclosed in Table 2 of Example 1. The evaluation results are report in Table 5.

TABLE 5

| | Panel 4.1 | Panel 4.2 |
|---|---|---|
| Prepreg | Example 3 | Example 3 |
| Lay-up | [0]160 | [0]300 |
| Max TC1 temperature [° C.] | 162.1 | 160.7 |
| Max TC2 temperature [° C.] | 166 | 168.4 |
| ΔT_{(Therm1-Therm2)} [° C.] | 3.9 | 7.7 |
| EoC [%] | 88 | 89 |

In the case of the 30 mm thick panel (Panel 4.1), the maximum temperature registered at the center of the mid ply (TC2) in the laminate was 166° C. while a maximum temperature of 162.4° C. was measured by the thermocouple between the top two plies (TC1). Therefore, a maximum difference of less than 4° C. was measured during the cure cycle. An average degree of cure of 88% with a standard variation of less than 1% from the outer to the central portion of the cured laminate was achieved.

Similarly, in the case of the 56 mm thick panel (Panel 4.2), the maximum temperature registered by TC2 was 168.4° C. with a maximum difference of just 7.7° C. compared to the maximu, temperature read by TC1. An average degree of cure of 89% with a standard variation of less than 1% from the outer to the central portion of the cured laminate was achieved.

The experiments described herein demonstrate that, when the amine curing agent, 4,4′-methylenebis(2,6-xylidine) is used in the matrix resin, thick composite structures up to a thickness of 56 mm can be fabricated without the need for lengthy intermediate dwell time during the cure cycle and the occurrence of uncontrolled exothermicity can be prevented. The controlled cure resulted in a very homogeneous degree of cure throughout the thickness of the laminate, and consequently, a homogeneous thermo-mechanical performance.

1. A composite material comprising reinforcement fibers impregnated with a thermoset resin composition comprising:
(A) an epoxy resin component consisting of a combination of multifunctional epoxy resins selected from difunctional, trifunctional and tetrafunctional polyepoxides;
(B) a curative component comprising 4,4′-methylenebis(2,6-xylidine); and
(C) a thermoplastic component,
wherein the thermoset resin composition is void of any catalyst or accelerator that is reactive with the epoxy resin(s).

2. The composite material of claim 1, wherein the curative component consists of 4,4′-methylenebis(2,6-xylidine) as the only curative in the thermoset resin composition.

3. The composite material of claim 1, wherein the curative component in the thermoset resin composition consists of 4,4′-methylenebis(2,6-xylidine) in combination with one or more other amine curatives, and the molar content of 4,4′-methylenebis(2,6-xylidine) is 50% of the total molar amount of all amines in the thermoset resin composition.

4. The composite material according to claim 1, wherein the relative amounts, in weight percentages (wt %), of the components in the thermoset resin composition are as follows: 30-75 wt % A, 20-30 wt % B, and 5-40 wt % C, based on the total weight of the thermoset resin composition.

5. The composite material according to claim 1, wherein thermoplastic component is a polyarylsulfone polymer.

6. The composite material according to claim 1, wherein the thermoplastic component comprises polyamide particles and a polyarylsulfone polymer.

7. The composite material according to claim 1, wherein the multifunctional epoxy resins are selected from: glycidylethers of aminophenols, and glycidylethers of diaminodiphenylmethane.

8. The composite material according to claim 1, wherein the epoxy resin component comprises:
(i) a trifunctional epoxy resin, preferably, triglycidyl p-aminophenol (TGPAP) or triglycidyl m-aminophenol (TGMAP); and/or
(ii) a tetrafunctional epoxy resin, preferably, tetraglycidyl diamino diphenyl methane (TGDDM);
in combination with
(iii) a difunctional epoxy resin, preferably, bisphenol A epoxy resin or bisphenol F epoxy resin.

9. The composite material according to claim 1, wherein the thermoset resin composition further comprises 0.1-10 wt % of inorganic fillers, based on the total weight of the thermoset resin composition.

10. The composite material according to claim 9, wherein the inorganic fillers are conductive fillers.

11. The composite material according to claim 3, wherein the other amine curative(s) is/are aromatic amines selected from:
3,3′-diaminodiphenylsulfone (3,3′-DDS); 4,4′-diaminodiphenylsulfone (4,4′-DDS); 1,4-bis(4-aminophenoxy)-2-phenylbenzene; 1,3-Bis(3-aminophenoxy)benzene; 4,4′-(m-phenylenediisopropylidene)dianiline; 4,4′-(p-phenylenediisopropylidene)dianiline; 2,2′-bis(4-(4-aminophenoxy)phenylpropane; 4,4′-bis(3-aminophenoxy)diphenylsulfone; 1,3-bis(3-aminophenoxy)benzene; and 4,4′-1,4-phenylenebis(1-methylethylindene)bisaniline.

12. The composite material according to claim 1, wherein the reinforcement fibers are in the form of continuous, unidirectionally aligned fibers or a woven fabric.

13. The composite material according to claim 1, wherein the reinforcement fibers are carbon fibers.

14. The composite material according to any claim 1, wherein the thermoset resin composition is in the form of a resin layer and the reinforcement fibers are embedded in said resin layer.

15. A method for fabricating a composite part, comprising:
forming one or more prepreg plies from the composite material according to claim 1;
placing the one or more prepreg plies on a tool surface; and
curing the one or more prepreg plies at a temperature in the range of 160° C.-180° C. for 15 to 120 minutes to produce a cured composite part with a degree of cure of greater than 85%.

16. The method of claim 15, wherein curing is carried out at a temperature in the range of 160° C.-170° C. for 15 to 60 minutes.

17. The method of claim 15, wherein the cured composite part has a glass transition temperature (T_{g}) in the range of 180° C.-200° C. in dry conditions and a T_{g} in the range of 150° C.-160° C. in hot/wet conditions after two weeks conditioning at 70° C./85% humidity, as determined by EN6032.

18. A thermoset resin composition comprising:
(A) an epoxy resin component consisting of a combination of multifunctional epoxy resins selected from difunctional, trifunctional and tetrafunctional polyepoxides;
(B) 4,4′-methylenebis(2,6-xylidine) as the only curative for the multifunctional epoxy resins; and
(C) a thermoplastic component,
wherein the thermoset resin composition is void of any catalyst or accelerator that is reactive with the epoxy resin(s).

19. A thermoset resin composition comprising:
(A) an epoxy resin component consisting of a combination of multifunctional epoxy resins selected from difunctional, trifunctional and tetrafunctional polyepoxides;
(B) a curative component consisting of 4,4′-methylenebis(2,6-xylidine) in combination with one or more other aromatic amines; and
(C) a thermoplastic component,
wherein the thermoset resin composition is void of any catalyst or accelerator that is reactive with the epoxy resin(s).

20. The thermoset resin composition of claim 19, wherein the other aromatic amine(s) is/are selected from:
3,3′-diaminodiphenylsulfone (3,3′-DDS); 4,4′-diaminodiphenylsulfone (4,4′-DDS); 1,4-bis(4-aminophenoxy)-2-phenylbenzene; 1,3-Bis(3-aminophenoxy)benzene; 4,4′-(m-phenylenediisopropylidene)dianiline; 4,4′-(p-phenylenediisopropylidene)dianiline; 2,2′-bis(4-(4-aminophenoxy)phenylpropane; 4,4′-bis(3-aminophenoxy)diphenylsulfone; 1,3-bis(3-aminophenoxy)benzene; and 4,4′-1,4-phenylenebis(1-methylethylindene)bisaniline.
